(19) United States
(12) Patent Application Publication
(10) Pub. No.: US 2015/0071299 A1
(43) Pub. Date: Mar. 12, 2015

(54) METHODOLOGY TO INCREASE BUFFER CAPACITY OF AN ETHERNET SWITCH

(71) Applicant: Gary Richard Burrell, West New York, NJ (US)

(72) Inventor: Gary Richard Burrell, West New York, NJ (US)

(21) Appl. No.: 14/024,097

(22) Filed: Sep. 11, 2013

(51) Int. Cl. H04L 12/873; H04L 12/863; H04L 12/26

(52) U.S. Cl. CPC H04L 47/522; H04L 43/02; H04L 47/6215
USPC 370/412

(57) ABSTRACT

A methodology to increase buffer capacity of an Ethernet switch uses an intelligent packet buffer at external ports of the Ethernet switch. Each intelligent packet buffer may include buffer logic and a buffered Ethernet port coupled to an internal Ethernet port of a switching element. The intelligent packet buffer may use a memory controller to access a random access memory using page mode access, and may write portions of a packet stream to a logical buffer in the random access memory that is dedicated to the internal Ethernet port. The intelligent packet buffer may forward the packet stream from the logical buffer to the internal Ethernet port. The logical buffer may represent a virtual output queue of the Ethernet switch associated with the internal Ethernet port. The intelligent packet buffer may be dimensioned with corresponding buffer logic and random access memory capacity to buffer one or more external ports.

### BACKGROUND

1. Field of the Disclosure

The present disclosure relates to networked communications and, more specifically, to increasing buffer capacity of an Ethernet switch.

2. Description of the Related Art

In telecommunications, information is often sent, received, and processed according to the Open System Interconnection Reference Model (OSI Reference Model or OSI Model). In its most basic form, the OSI Model divides network architecture into seven layers which, from top to bottom, are the Application, Presentation, Session, Transport, Network, Data-Link, and Physical Layers, which are also known respectively as Layer 7 (L7), Layer 6 (L6), Layer 5 (L5), Layer 4 (L4), Layer 3 (L3), Layer 2 (L2), and Layer 1 (L1). It is therefore often referred to as the OSI Seven Layer Model.

Layer 1 is the physical layer and is often denoted as “PHY”. Layer 1 includes the physical interfaces for transmitting raw data in the form of bits over a physical link that connects network nodes. Because Layer 1 provide the physical means for network connections, Layer 1 includes specifications for connectors, transmission frequencies, and modulation formats. A common example of Layer 1 is the Ethernet physical layer, which may specify different types of variants, including, among others, 10BASE-T, 100BASE-T, 1000BASE-T, 10GBASE-LR, 40GBASE-LR4, etc.

Layer 2 is the data link layer which typically transfers data between adjacent network nodes in a wide area network or between nodes on the same local area network segment. Layer 2 provides the functional and procedural means to transfer data between network entities and may provide the means to detect and possibly correct errors that may occur in the Layer 1. Examples of Layer 2 protocols are Ethernet for local area networks (multi-node), the Point-to-Point Protocol (PPP), High-Level Data Link Control (HDLC), and Advanced Data Communication Control Procedures (ADCCP) for point-to-point (dual-node) connections. Layer 2 data transfer may be handled by devices known as switches. Layer 2 may include a sublayer that provides addressing and channel access control mechanisms for an Ethernet shared medium, referred to as a media access control (MAC) protocol, while a hardware device that instantiates the MAC protocol along with Layer 1 functionality is referred to as a medium access controller.

Layer 3 is responsible for end-to-end (source to destination) packet delivery including routing through intermediate hosts, whereas the Layer 2 is responsible for node-to-node (e.g., hop-to-hop) frame delivery on the same link. Perhaps the best known example of a Layer 3 protocol is Internet Protocol (IP). Layer 3 data transfer may be handled by devices known as routers.

A particular network element (e.g., a switch or a router) may forward network traffic based on contents of a forwarding table resident upon the network element that associates unique identifiers (e.g., addresses such as MAC addresses and IP addresses) of other network elements coupled to the particular network element to egress interfaces of the particular network element. Thus, in order to determine the proper egress interface to which an ingress interface should forward traffic to be transmitted by the network element, switching logic of the network element may examine the traffic to determine a destination address for the traffic, and then perform a lookup in the forwarding table to determine the egress interface associated with such destination address.

As network elements switch and/or route network traffic, the volume (i.e., the data rate) of the network packets arriving at a particular network element may vary. For example, network packets may sometimes arrive at a network element in large, sudden bursts that may temporarily exceed a processing capacity of the network element, and may result in undesirable packet losses. Certain network elements employing switching logic may employ centralized packet buffering to accommodate bursts in network traffic. However, switching logic in a network element that is customized with a large central packet buffer memory may still be limited in data throughput rates and may not be cost effective. Other solutions for handling high burst network traffic, such as the use of traffic managers with large packet memories, may also be costly and present their own unique operational challenges in implementation.

### SUMMARY

In one aspect, a disclosed method for buffering Ethernet packets includes receiving a first packet stream intended for a first Ethernet port of a switching element, and determining a classification for the first packet stream, the classification determined from packet information included in the first packet stream. Based on the classification, the method may include selecting a logical buffer in a random access memory device, the logical buffer dedicated to the first Ethernet port. The method may further include writing, to the logical buffer, at least a portion of the first packet stream, and forwarding, from the logical buffer, the first packet stream to the first Ethernet port.

Additional disclosed aspects for intelligent packet buffering include an intelligent packet buffer for buffering network packets and an Ethernet switch including a plurality of intelligent packet buffers.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected elements of an embodiment of a network according to the present disclosure;

FIG. 2 is a block diagram of selected elements of an embodiment of an Ethernet network element according to the present disclosure;

FIGS. 3A, 3B, and 3C each show a block diagram of selected elements of an embodiment of an intelligent packet buffer according to the present disclosure;

FIG. 4 is a flow chart of selected elements of an embodiment of a method for intelligent packet buffering according to the present disclosure; and

FIG. 5 is a flow chart of selected elements of an embodiment of a method for intelligent packet buffering according to the present disclosure.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

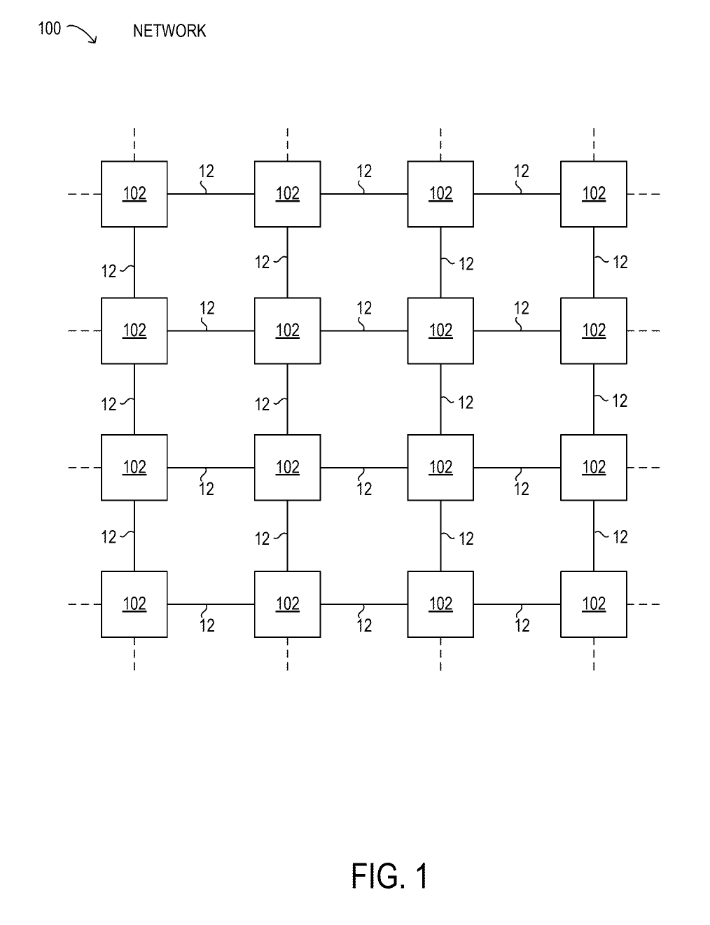

Turning now to the drawings, FIG. 1 is a block diagram showing selected elements of an embodiment of network 100. In certain embodiments, network 100 may be an Ethernet network. Network 100 may include one or more transmission media 12 operable to transport one or more signals communicated by components of network 100. The components of network 100, coupled together by transmission media 12, may include a plurality of network elements 102. In the illustrated network 100, each network element 102 is coupled to four other nodes. However, any suitable configuration of any suitable number of network elements 102 may create network 100. Although network 100 is shown as a mesh network, network 100 may also be configured as a ring network, a point-to-point network, or any other suitable network or combination of networks. Network 100 may be used in a short-haul metropolitan network, a long-haul inter-city network, or any other suitable network or combination of networks.

Each transmission medium 12 may include any system, device, or apparatus configured to communicatively couple network elements 102 to each other and communicate information between corresponding network elements 102. For example, a transmission medium 12 may include an optical fiber, an Ethernet cable, a T1 cable, a WiFi signal, a Bluetooth signal, or other suitable medium.

Network 100 may communicate information or “traffic” over transmission media 12. As used herein, “traffic” means information transmitted, stored, or sorted in network 100. Such traffic may comprise optical or electrical signals configured to encode audio, video, textual, and/or any other suitable data. The data may also be transmitted in a synchronous or asynchronous manner, and may be transmitted deterministically (also referred to as ‘real-time’) and/or stochastically. Traffic may be communicated via any suitable communications protocol, including, without limitation, the Open Systems Interconnection (OSI) standard and the Internet Protocol (IP). Additionally, the traffic communicated via network 100 may be structured in any appropriate manner including, but not limited to, being structured in frames, packets, or an unstructured bit stream.

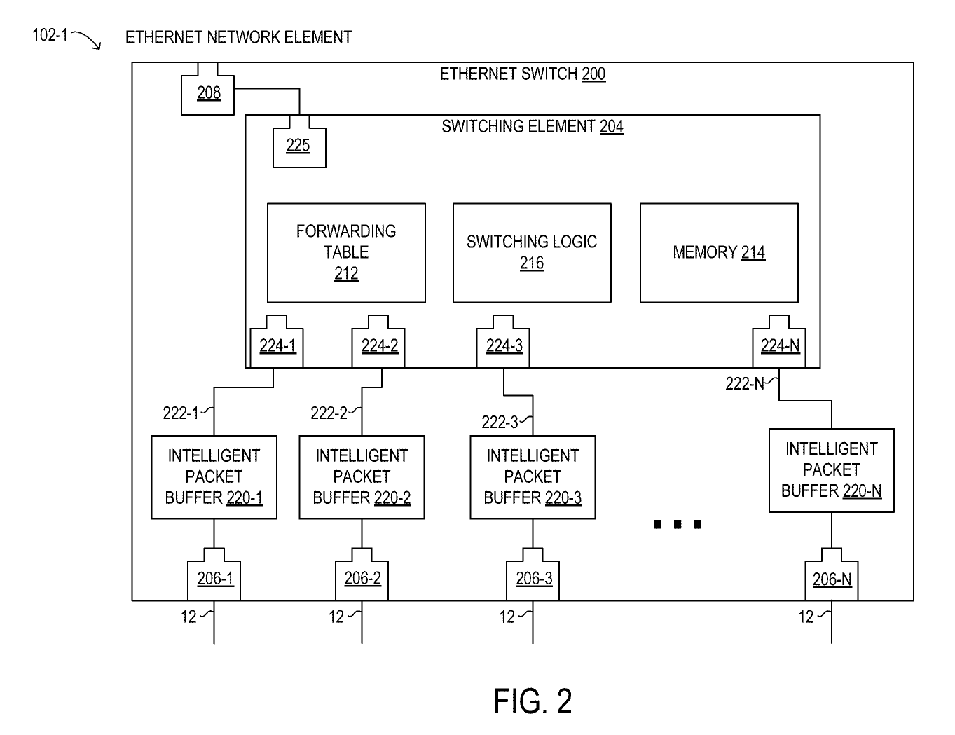

Each network element 102 in network 100 may comprise any suitable system operable to transmit and receive traffic. In the illustrated embodiment, each network element 102 may be operable to transmit traffic directly to one or more other network elements 102 and receive traffic directly from the one or more other network elements 102. Network elements 102 will be discussed in more detail below with respect to FIG. 2.

Modifications, additions, or omissions may be made to network 100 without departing from the scope of the disclosure. The components and elements of network 100 described may be integrated or separated according to particular needs. Moreover, the operations of network 100 may be performed by more, fewer, or other components.

In operation of network 100, certain network elements 102 may include switching logic to switch network packets from an ingress port to an egress port and may accordingly be referred to as network switches, or simply, switches. Network switches may be available in various classes, corresponding to the network throughput rates supported. For example, a carrier class network switch may operate with data rates greater than about 10 gigabits per second (10 GB/s or simply 10G), while enterprise class network switches may be used for data rates less than about 10 GB/s. However, as data rates increase, the cost and/or complexity of large carrier class network switches may increase significantly and disproportionately to the achieved data rates. Conversely, in the enterprise class market space for network switches, many low-cost off-the-shelf solutions, including packaged integrated circuits (i.e., chips), for switching logic are widely available, albeit at limited data throughput rates with a limited ability to handle high-burst traffic.

In order to maintain a desired level of quality of service (QoS) in network 100, network switches should be able to handle the traffic volumes presented to them without packet losses. As overall data rates increase, the amount of traffic that arrives in sudden peaks, or bursts, may present a challenge to a standard network switch with little or no buffering capacity. Even when packet buffering is provided in a network switch in the form of a centralized memory accessible to the switching logic, the data throughput rates may still be limited by performance constraints associated with the central memory, which may have a limited number of access channels and, therefore, a latency of memory access that is too high for switching high throughput data streams. Efforts to improve the performance of a central memory available to switching logic of a network switch may involve substantial cost and technical complexity that ultimately outweigh any benefit achieved.

As will be described in further detail, network elements 102 that include switching logic may use an intelligent packet buffer at each port to perform packet buffering. The packet buffering may be performed by the intelligent packet buffer on ingress (i.e., incoming or input) ports and/or individual data streams arriving at a port. In this manner, the intelligent packet buffer disclosed herein may enable standard switching logic to implement virtual output queues (VOQs) for each output port, without expensive customization, such as implementing centralized queues and associated scheduling algorithms. Additionally, the intelligent packet buffer may classify network packets by examining packet information included in the network packets and assigning packets to one of multiple VOQs associated with each port. The packet information used for classification and assignment may include priority information, virtual local area network (VLAN) information, packet flow, stream information (such as destination and/or source fields included in the packet streams), and/or other types of packet information. Accordingly, different VOQs may be created and may operate simultaneously at each port. For example, a high priority VOQ handling voice or audio traffic may be created alongside a lower priority VOQ for handling document data for a given port. The high priority VOQ and the low priority VOQ may be created with different storage capacity in the intelligent packet buffer, corresponding to the rate of the incoming data stream and/or servicing requirements of the particular VOQ.

The intelligent packet buffering, as described herein, may be usable to improve the performance of standard low-cost switching logic, resulting in a network switch that is both low-cost and able to handle switching of high burst traffic in network 100. Furthermore, the intelligent packet buffering disclosed herein may be transparent to logical and/or physical entities in network 100, and may accordingly be well-suited for rapid deployment and widespread use.

Referring now to FIG. 2, a block diagram of selected elements of an embodiment of exemplary Ethernet network element 102-1 is illustrated. As discussed above with respect to FIG. 1, each network element 102 may be coupled to one or more other network elements 102 via one or more transmission media 12. Each network element 102 may generally be configured to receive data from and/or transmit data to one or more other network elements 102. In certain embodiments, network element 102 may comprise a switch or router configured to route data received by network element 102 to another device (e.g., another network element 102) coupled to network element 102. As shown in FIG.2, Ethernet network element 102-1 is an instance of Ethernet switch 200 that switches network packets between external ports 206 for use in network 100, and includes switching element 204 that is internally coupled to respective intelligent packet buffers 220 for each of external ports 206.

In FIG. 2, switching element 204 may include a suitable system, apparatus, or device configured to receive traffic and forward such traffic via internal ports 224, based on analyzing the contents of the network packets that form the traffic. As depicted in FIG. 2, switching element 204 may include forwarding table 212, switching logic 216, and memory 214. Forwarding table 212 may be used by switching element 204 to forward traffic, and may include a table, map, database, and/or other data structure for associating each internal port 224 with one or more other network entities (e.g., other network elements 102). Switching logic 216 may represent switching functionality of switching element 204 and may be implemented using various means, such as, but not limited to, at least one microprocessor and/or at least one field-programmable gate array (FPGA) and/or a system on chip (SoC). The use of an FPGA for at least certain portions of switching logic 216 may be particularly advantageous due to the deterministic parallelism between input/output (I/O) nodes that an FPGA can deliver. It is noted that an SoC used for switching logic 216 may include a combination of at least one microprocessor and at least one FPGA. Memory 214 may be available to switching logic 216 for various purposes, but may be constrained by design in an ability to enable switching of high burst traffic for multiple ports, as noted previously.

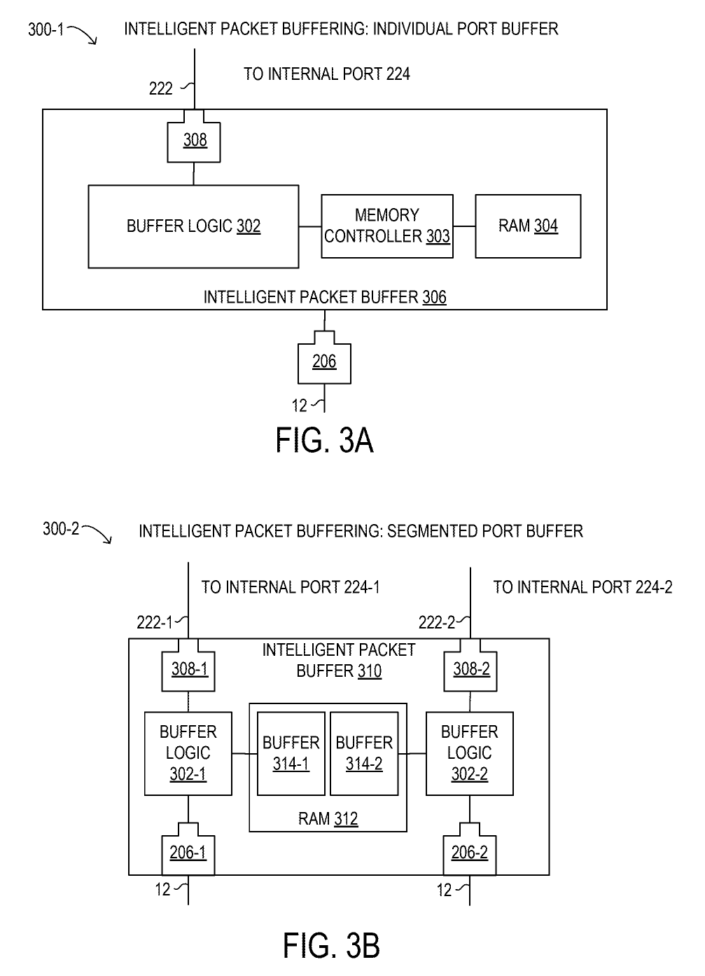

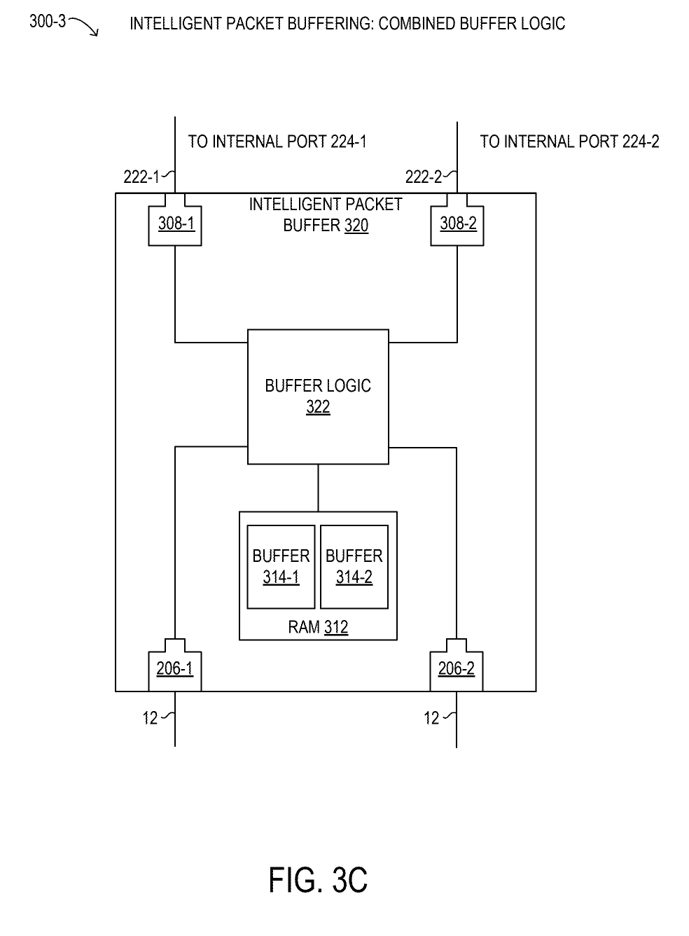

As shown in FIG. 2, switching element 204 may include internal ports 224 that are respectively connected to internal buffered ports (see FIGS. 3A, 3B, element 308) of intelligent packet buffer 220 via internal port links 222. Thus, port links 222 may represent communication means between switching element 204 and intelligent packet buffers 220. In certain embodiments, switching element 204 may be an embedded network switch that is itself capable of independent operation as an Ethernet switch using internal ports 224. In other embodiments, Ethernet switch 200 may be implemented as unitary electronic device (e.g., a board level device) in which switching element 204 and intelligent packet buffer 220 are implemented as components and/or subsystems (e.g., semiconductor devices or chips), port links 222 are formed within the unitary electronic device as fixed connection lines, and internal ports 224 represent fixed connections to switching element 204. In certain embodiments, switching element 204 may be unaware of intelligent packet buffers 220 and/or external ports 206, and may receive and forward traffic via external ports 206 by virtue of the connection arrangement depicted in FIG. 2, and may only be aware of the internal ports 224 coupled to port links 222.

Also in FIG. 2, Ethernet switch 200 may include internal stacking port 225 that connects to external stacking port 208 to enable aggregation of additional Ethernet switches (not shown) with Ethernet switch 200. In this manner, multiple Ethernet switches may be aggregated to operate as a single logical switching entity that employs intelligent packet buffering across all aggregated ports.

In FIG. 2, Ethernet switch 200 is shown with N number of external ports 206, where N is an arbitrary number, that provide a physical connection to transmission media 12 (see FIG. 1). Specifically, external port 206-1 may be linked to (or included in) intelligent packet buffer 220-1, which may also have an internal buffered port (see FIGS. 3A, 3B, and 3C; element 308) connected to port link 222-1, which may connect to a first internal port 224-1 of switching element 204; external port 206-2 may be linked to (or included in) intelligent packet buffer 220-2, which may also have an internal buffered port connected to port link 222-2, which may connect to a second internal port 224-2 of switching element 204; external port 206-3 may be linked to (or included in) intelligent packet buffer 220-3, which may also have an internal buffered port connected to port link 222-3, which may connect to a third internal port 224-3 of switching element 204. This arrangement may be repeated up to external port 206-N, which may be linked to (or included in) intelligent packet buffer 220-N, which may also have an internal buffered port connected to port link 222-N, which may connect to an Nth internal port 224-N of switching element 204. It is noted that intelligent packet buffers 220 may operate without a direct connection between themselves and may be solely linked via switching element 204.

In operation of Ethernet switch 200, switching element 204 may operate independently as a network switch and switch traffic between internal ports 224 that are respectively connected to port links 222.

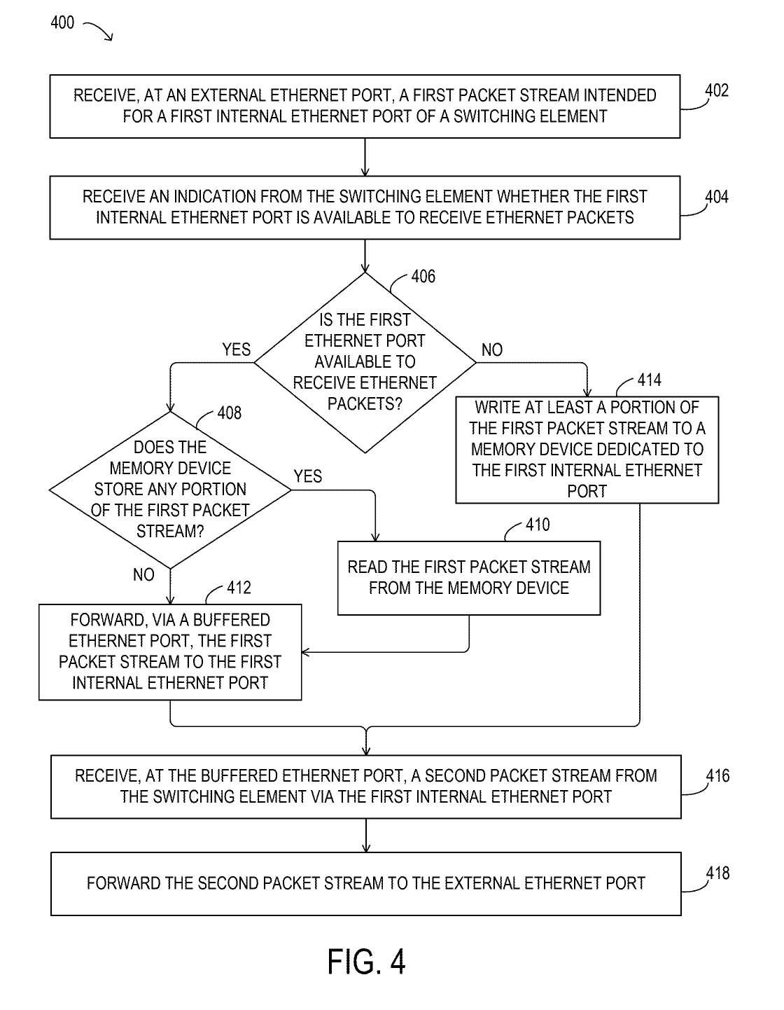

In one operational embodiment, intelligent packet buffer 220 may operate in a so-called “cut through mode” (see FIG. 4) in conjunction with switching element 204. In cut through mode, when switching element 204 becomes overloaded, for example, due to high burst traffic, one or more of internal ports 224 may become unavailable to receive network packets at a given point in time, and any network packets sent to internal port 224, when unavailable, will be lost. Intelligent packet buffer 220 may receive traffic via external port 206 intended for switching element 204 and may forward packets to switching element 204 via an internal buffered port via port link 222. When internal port 224 is available to receive traffic, intelligent packet buffer 220 may directly forward traffic to internal port 224. When internal port 224 becomes unavailable, intelligent packet buffer 220 may detect that packets are not being received at internal port 224 (via port link 222) and may begin to buffer such packets in a random access memory local to intelligent packet buffer 220, and correspondingly dedicated to internal port 224. When internal port 224 becomes available again after incoming traffic for internal port 224 has been buffered, intelligent packet buffer 220 may resume forwarding of buffered packets via port link 222 to internal port 224.

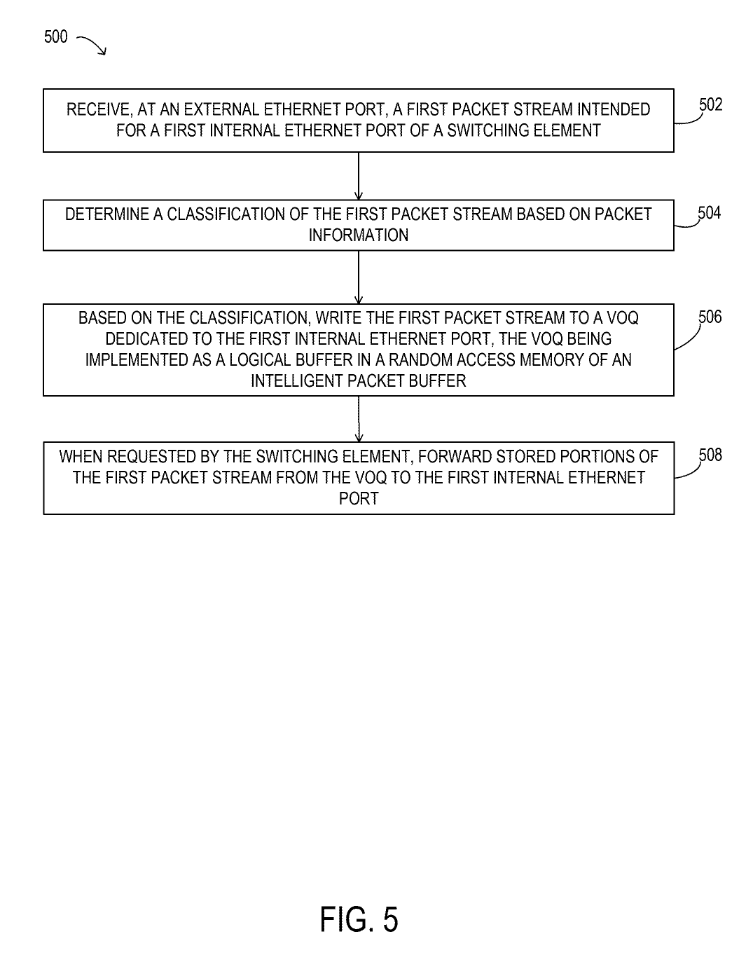

In another operational embodiment, intelligent packet buffer 220 may operate in a so-called “store and forward mode” (see FIG. 5) in conjunction with switching element 204. In store and forward mode, intelligent packet buffer 220 may receive traffic via external port 206 intended for switching element 204 and may store all received packets in the random access memory local to intelligent packet buffer 220. Then, the packets stored in the random access memory may be forwarded to switching element 204. In this case, a packet may not be available for forwarding to switching element 204 until a sufficient portion of the packet has been written to the random access memory to avoid underflow issues.

In various embodiments, intelligent packet buffer 220 may classify the incoming traffic according to packet parameters and may accordingly be able to buffer the incoming packets as individual packet streams, for example, using a logical buffer for each packet stream. A packet stream may represent network traffic that has some logical coherency, such as a common origin and destination, a real-time transmission of multimedia content (audio, video, etc.), packets belonging to a virtual local area network (VLAN), and/or other shared packet parameters/data. Accordingly, the packet stream may include packet information that can be used to classify the packet stream for network switching purposes. Thus, intelligent packet buffer 220 may be able to independently classify and buffer traffic using the random access memory.

In particular embodiments, intelligent packet buffer 220 may establish one or more logical buffers in the random access memory. The logical buffer may be segmented into blocks, or memory pages, for storing larger portions of a packet stream, rather than storing and retrieving individual packets, for increased performance of memory access. The logical buffers may represent VOQs for switching element 204 and may be dedicated to one or more particular packet streams.

In this manner, intelligent packet buffer 220 may significantly expand the ability of Ethernet switch 200 to handle high burst traffic and, in turn, increase an overall data rate that Ethernet switch 200 can support, without costly modifications and/or customizations to switching element 204, whose overall throughput is also increased. Intelligent packet buffer 220 may accordingly expand the usability of Ethernet switch 200 to network environments having various types of traffic patterns or shapes. It is further noted that intelligent packet buffer 220 may simply perform packet buffering while switching element 204 performs packet switching in Ethernet switch 200.

Additionally, since internal ports 224 and external ports 206 are bi-directional, intelligent packet buffer 220 may receive traffic from internal port 224 via port link 222 and forward such traffic to external port 206. In various embodiments, intelligent packet buffer 220 may not buffer outgoing traffic and may assume that a network element 102 receiving outgoing traffic from external port 206 via transmission media 12 is itself responsible for internal buffering of incoming traffic. It is noted that buffering of incoming traffic may be understood as an arbitrary convention among network elements 102 and may be replaced with output buffering using intelligent packet buffers 220 in a similar manner to the input buffering described above, but in the reverse direction.

Turning now to FIG. 3A, a block diagram of selected elements of an embodiment of intelligent packet buffering 300-1 is illustrated. As shown, intelligent packet buffering 300-1 represents an embodiment using an individual random access memory and buffer logic for each of external ports 206. In FIG. 3A, intelligent packet buffer 306 represents an embodiment of intelligent packet buffer 220 (see FIG. 2) in which external port 206 is externally coupled to intelligent packet buffer 306. It is noted that the link between external port 206 and intelligent packet buffer 306 may be a fixed internal link within Ethernet switch 200 (see FIG. 2). As shown, intelligent packet buffer 306 may represent an L1/L2 (i.e., PHY/MAC) device with external port 206 supporting transmission media 12. Intelligent packet buffer 306, as shown, includes buffer logic 302, random access memory (RAM) 304, and internal buffered port 308. Buffer logic 302, as shown in FIG. 3A, may represent logical functionality of intelligent packet buffer 306 for internal port 224 and may be implemented using various means, such as, but not limited to, at least one microprocessor and/or at least one field-programmable gate array (FPGA) and/or a system on chip (SoC). The use of an FPGA for at least certain portions of buffer logic 302 may be particularly advantageous due to the deterministic parallelism between input/output (I/O) nodes that an FPGA can deliver. It is noted that an SoC used for buffer logic 302 may include a combination of at least one microprocessor and at least one FPGA. As shown in the exemplary embodiment of intelligent packet buffer 300-1, buffer logic 302 may use memory controller 303 that supports page mode access for accessing RAM 304. In other embodiments (not shown), memory controller 303 may be included within buffer logic 302. Intelligent packet buffer 306 may further couple to internal port 224 via port link 222, as described above with respect to FIG. 2. In operation, intelligent packet buffer 306 may buffer incoming traffic using RAM 304, which may be exclusive to intelligent packet buffer 306. Specifically, buffer logic 302 may forward buffered and/or unbuffered incoming traffic to internal port 224 of switching element 204 (see FIG. 2) via internal buffered port 308. Intelligent packet buffer 306 may further receive outgoing traffic via internal buffered port 308 and forward the outgoing traffic to external port 206.

Turning now to FIG. 3B, a block diagram of selected elements of an embodiment of intelligent packet buffering 300-2 is illustrated. In the exemplary embodiment shown in FIG. 3B, intelligent packet buffering 300-2 represents an embodiment in which a segmented port buffer is implemented in a random access memory for two of external ports 206-1 and 206-2. In FIG. 3B, intelligent packet buffer 310 represents an embodiment of intelligent packet buffer 220 (see FIG. 2) in which external ports 206-1, 206-2 are integrated within intelligent packet buffer 310. As shown, intelligent packet buffer 310 may represent an L1/L2 (i.e., PHY/MAC) device with external ports 206-1, 206-2 supporting transmission media 12. Intelligent packet buffer 310, as shown, includes buffer logic 302-1, 302-2, RAM 312, and internal buffered ports 308-1, 308-2. In various embodiments, intelligent packet buffer 310 may include a memory controller (not shown in FIG. 3B, see FIG. 3A) for accessing RAM 312 and/or buffers 314 that supports page mode access. In certain embodiments, the memory controller may be included within buffer logic 302. Intelligent packet buffer 310 may further couple to internal port 224-1 from internal buffered port 308-1 via port link 222-1, and may further couple to internal port 224-2 from internal buffered port 308-2 via port link 222-2, as described above with respect to FIG. 2.

In operation, intelligent packet buffer 310 may independently buffer incoming traffic from external ports 206-1, 206-2, using RAM 312, which may be exclusive to intelligent packet buffer 310. In RAM 312, buffer 314-1 is dedicated to buffer logic 302-1, while buffer 314-2 is dedicated to buffer logic 302-2. The buffers 314 may further include one or more logical buffers and/or VOQs (not shown) respectively associated with internal ports 224, as described previously. Buffer logic 302-1 may forward buffered and/or unbuffered traffic to internal port 224-1 of switching element 204 via internal buffered port 308-1, while buffer logic 302-2 may forward buffered and/or unbuffered traffic to internal port 224-2 of switching element 204 via internal buffered port 308-2 (see FIG. 2). Intelligent packet buffer 310 may further receive outgoing traffic via internal buffered ports 308-1, 308-2, and forward the outgoing traffic to external ports 206-1, 206-2, respectively. It is noted that intelligent packet buffering 300-2 using RAM 312 shared between buffer logic 302-1 and 302-2 may be an advantageous embodiment in certain applications, for example, when cost and/or availability favors a certain capacity of memory 312 that supports a relatively high data rate, while Ethernet switch 200 is designed for a lower data rate. In this manner, a larger capacity memory 312 may be better economized for the performance desired in Ethernet switch 200. Although the arrangement shown in FIG. 3B shares physical memory between two ports, similar arrangements of sharing a physical memory device among a larger number of ports (4, 8, 16, 24, etc.) may be implemented in other embodiments.

Turning now to FIG. 3C, a block diagram of selected elements of an embodiment of intelligent packet buffering 300-3 is illustrated. In the exemplary embodiment shown in FIG. 3C, intelligent packet buffering 300-3 represents an embodiment in which a segmented port buffer is implemented in a random access memory for two of external ports 206-1 and 206-2 and in which buffer logic is also shared between the two ports. In FIG. 3C, intelligent packet buffer 320 represents an embodiment of intelligent packet buffer 220 (see FIG. 2) in which external ports 206-1, 206-2 are integrated within intelligent packet buffer 320. As shown, intelligent packet buffer 320 may represent an L1/L2 (i.e., PHY/MAC) device with external ports 206-1, 206-2 supporting transmission media 12. Intelligent packet buffer 320, as shown, includes buffer logic 302-1, 302-2, RAM 312, and internal buffered ports 308-1, 308-2. In various embodiments, intelligent packet buffer 320 may include a memory controller (not shown in FIG. 3C, see FIG. 3A) for accessing RAM 312 and/or buffers 314 that supports page mode access. In certain embodiments, the memory controller may be included within buffer logic 322. Intelligent packet buffer 320 may further couple to internal port 224-1 from internal buffered port 308-1 via port link 222-1, and may further couple to internal port 224-2 from internal buffered port 308-2 via port link 222-2, as described above with respect to FIG. 2.

In operation, intelligent packet buffer 320 may independently buffer incoming traffic from external ports 206-1, 206-2, using RAM 312, which may be exclusive to intelligent packet buffer 320. In RAM 312, buffer 314-1 may be dedicated to internal port 224-1, while buffer 314-2 is dedicated to internal port 224-2. The buffers 314 may further include one or more logical buffers and/or VOQs (not shown) respectively associated with internal ports 224, as described previously. Buffer logic 322 may forward buffered and/or unbuffered traffic to internal port 224-1 of switching element 204 via internal buffered port 308-1, and may forward buffered and/or unbuffered traffic to internal port 224-2 of switching element 204 via internal buffered port 308-2 (see FIG. 2). Intelligent packet buffer 320 may further receive outgoing traffic via internal buffered ports 308-1, 308-2, and forward the outgoing traffic to external ports 206-1, 206-2, respectively. It is noted that intelligent packet buffering 300-2 using RAM 312 under control of common buffer logic 322 may be an advantageous embodiment in certain applications, in which buffer logic 322 provides sufficient processing capacity to handle buffering operations for multiple ports and a larger capacity memory 312 may be better economized for the performance desired in Ethernet switch 200. Although the arrangement shown in FIG. 3C shares buffer logic and physical memory between two ports, similar arrangements of sharing buffer logic and a physical memory device among a larger number of ports (4, 8, 16, 24, etc.) may be implemented in other embodiments.

Turning now to FIG. 4, a block diagram of selected elements of an embodiment of method 400 for performing intelligent packet buffering is shown in flow chart format. Method 400 may represent an embodiment including cut through mode, as described previously. It is noted that certain operations depicted in method 400 may be rearranged or omitted, as desired. It is further noted that certain portions of methods 400 and 500 may be combined in different embodiments.

Method 400 may begin by receiving (operation 402), at an external Ethernet port, a first packet stream intended for a first internal Ethernet port of a switching element. The switching element may, at least in part, include Ethernet switching functionality. An indication may be received (operation 404) from the switching element whether the first internal Ethernet port is available to receive Ethernet packets. The indication in operation 404 may be provided using an Ethernet protocol. The indication in operation 404 may be specific to the first packet stream or may be generalized for all incoming traffic intended for the first internal Ethernet port. Then, a decision may be made whether the first Ethernet port is available to receive Ethernet packets (operation 406). The decision in operation 406 may be based on the indication received in operation 404. When the result of operation 406 is NO, method 400 may proceed to write at least a portion of the first packet stream to a memory device dedicated to the first internal Ethernet port (operation 414). At least a portion of the memory device may be dedicated to the external Ethernet port, and correspondingly, dedicated to the first internal Ethernet port. When the result of operation 406 is YES, method 400 may proceed to make a subsequent decision, whether the memory device stores any portion of the first packet stream (operation 408). When the result of operation 408 is YES, method 400 may read (operation 410) the first packet stream from the memory device. After operation 410 or when the result of operation 408 is NO, the first packet stream may be forwarded (operation 412) via a buffered Ethernet port to the first internal Ethernet port. After operation 412 or after operation 414, a second packet stream may be received (operation 416) at the buffered Ethernet port from the switching element via the first internal Ethernet port. The second packet stream may be forwarded (operation 418) to the external Ethernet port. It is noted that while certain operations or groups of operations are depicted in method 400 sequentially for descriptive clarity, various operations may be executed in parallel, continuously, or iteratively. For example, operations 402-414 may represent intelligent input buffering that is continuously performed, while operations 416-418 may represent output without buffering that is continuously performed in parallel to operations 402-414. Operations or groups of operations performed in parallel may be implemented as parallel logical blocks in an FPGA.

Turning now to FIG. 5, a block diagram of selected elements of an embodiment of method 500 for performing intelligent packet buffering is shown in flow chart format. Method 500 may represent an embodiment including store and forward mode, as described previously. It is noted that certain operations depicted in method 500 may be rearranged or omitted, as desired. It is further noted that certain portions of methods 400 and 500 may be combined in different embodiments.

Method 500 may begin by receiving (operation 502), at an external Ethernet port, a first packet stream intended for a first internal Ethernet port of a switching element. The switching element may, at least in part, include Ethernet switching functionality. A classification of the first packet stream may be determined (operation 504) based on packet information. The packet information may be obtained from scanning individual packets in the first packet stream. Based on the classification, the first packet stream may be written (operation 506) to a VOQ dedicated to the first internal Ethernet port, the VOQ being implemented as a logical buffer in a random access memory of an intelligent packet buffer. The write operation in operation 506 may be a page mode operation having low latency and high data throughput to the random access memory. When requested by the switching element, stored portions of the first packet stream may be forwarded (operation 508) from the VOQ to the first internal Ethernet port.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for buffering Ethernet packets, comprising:
receiving a first packet stream intended for a first Ethernet port of a switching element;
determining a classification for the first packet stream, the classification determined from packet information included in the first packet stream;
based on the classification, selecting a logical buffer in a random access memory device, the logical buffer dedicated to the first Ethernet port;
writing, to the logical buffer, at least a portion of the first packet stream; and
forwarding, from the logical buffer, the first packet stream to the first Ethernet port.

2. The method of claim 1, wherein forwarding from the logical buffer is performed responsive to receiving an indication from the switching element that the first Ethernet port is available to receive Ethernet packets.

3. The method of claim 1, wherein the logical buffer is reserved for the first packet stream.

4. The method of claim 1, wherein the logical buffer is a virtual output queue of the switching element.

5. The method of claim 1, wherein the packet information is selected from at least one of: packet priority information, virtual local area network (VLAN) information, destination information, and source information.

6. The method of claim 1, wherein the random access memory device includes a plurality of logical buffers respectively dedicated to a plurality of Ethernet ports, including the first Ethernet port.

7. The method of claim 1, wherein writing to the logical buffer includes:
writing to the logical buffer using page mode access to the random access memory device.

8. An intelligent packet buffer for buffering network packets, comprising:
an external port;
a buffered port coupled to a first network port of a network switching element;
a random access memory device; and
buffer logic to:
receive, at the external port, a first packet stream intended for the first network port;
determine a classification for the first packet stream, the classification determined from packet information included in the first packet stream;
based on the classification, identify a logical buffer in the random access memory device, the logical buffer dedicated to the first network port;
write, to the logical buffer, at least a portion of the first packet stream; and
forward, from the logical buffer via the buffered port, the first packet stream to the first network port.

9. The intelligent packet buffer of claim 8, wherein the buffer logic to forward from the logical buffer is performed responsive to receiving an indication from the network switching element that the first network port is available to receive network packets.

10. The intelligent packet buffer of claim 8, wherein the buffer logic is implemented in a field-programmable gate array (FPGA) and the random access memory device is external to the FPGA.

11. The intelligent packet buffer of claim 8, wherein the logical buffer is a virtual output queue of the switching element.

12. The intelligent packet buffer of claim 11, wherein the logical buffer is reserved for the first packet stream.

13. The intelligent packet buffer of claim 8, wherein the packet information is selected from at least one of: packet priority information, virtual local area network (VLAN) information, destination information, and source information.

14. The intelligent packet buffer of claim 8, wherein the random access memory device includes a plurality of logical buffers respectively dedicated to a plurality of network ports, including the first network port.

15. The intelligent packet buffer of claim 8, wherein the buffer logic to write to the logical buffer includes buffer logic to:
use a memory controller to write to the random access memory device using page-mode access.

16. An Ethernet switch, comprising:
a switching element comprising a first plurality of internal Ethernet ports, including a first internal Ethernet port;
switching logic in the switching element to route Ethernet packets between the internal Ethernet ports; and
a plurality of intelligent packet buffers coupled to the internal Ethernet ports, including a first intelligent packet buffer, wherein each of the intelligent packet buffers comprises:
an external Ethernet port;
a buffered Ethernet port coupled to an internal Ethernet port of the switching element;
a random access memory device; and
buffer logic, and
wherein the first intelligent packet buffer includes first buffer logic to:
receive, at a first external Ethernet port included in the first intelligent packet buffer, a first packet stream intended for the first internal Ethernet port;
determine a classification for the first packet stream, the classification determined from packet information included in the first packet stream;
based on the classification, identify a logical buffer in a random access memory device, the logical buffer dedicated to the first internal Ethernet port;
write, to the logical buffer, at least a portion of the first packet stream; and
forward, from the logical buffer via a first buffered Ethernet port included in the first intelligent packet buffer, the first packet stream to the first internal Ethernet port.

17. The Ethernet switch of claim 16, wherein the first buffer logic to forward from the logical buffer is performed responsive to receiving an indication from the switching element that the first internal Ethernet port is available to receive network packets.

18. The Ethernet switch of claim 16, wherein the first buffer logic is implemented in a field-programmable gate array (FPGA) and the random access memory device is external to the FPGA.

19. The Ethernet switch of claim 16, wherein the first logical buffer is a virtual output queue of the switching element.

20. The Ethernet switch of claim 19, wherein the first logical buffer is reserved for the first packet stream.

21. The Ethernet switch of claim 16, wherein the packet information is selected from at least one of: packet priority information, virtual local area network (VLAN) information, destination information, and source information.

22. The Ethernet switch of claim 16, wherein the random access memory device includes a plurality of logical buffers respectively dedicated to a second plurality of internal Ethernet ports that is a subset of the first plurality of internal Ethernet ports.

23. The Ethernet switch of claim 16, wherein the buffer logic to write to the logical buffer includes buffer logic to:
use a memory controller to write to the random access memory device using page-mode access.
